(19) United States
(12) Patent Application Publication
(10) Pub. No.: US 2026/0313718 A1
(43) Pub. Date: Oct. 8, 2026

(54) METHODS, ARCHITECTURES, APPARATUSES AND SYSTEMS FOR ENERGY-AWARE UE-TO-NETWORK RELAYING SERVICES

(71) Applicant: InterDigital Patent Holdings, Inc., Wilmington, DE (US)

(72) Inventors: Achref Methenni, Montreal (CA); Jung Je Son, Warrington, PA (US); Taimoor Abbas, Sainte-Julie (CA); Samir Ferdi, Kirkland (CA)

(21) Appl. No.: 19/171,642

(22) Filed: Apr. 7, 2025

(51) Int. Cl. H04W 76/10; H04W 8/00; H04W 24/08; H04W 76/20; H04W 76/30

(52) U.S. Cl. CPC H04W 76/10; H04W 8/005; H04W 24/08; H04W 76/20; H04W 76/30

(57) ABSTRACT

Procedures, methods, architectures, apparatuses, systems, devices, and computer program products for energy-aware UE-to-network relaying. A relay device establishes a connection with a remote device, monitors energy consumption related to data traffic forwarded through the relay device for the remote device, and, in response to detecting an energy-related event affecting an ability of the relay device to respect an energy criterion negotiated with the remote device, sends, to the remote device, information indicative of a request to alter the connection, and alters the connection.

### TECHNICAL FIELD

The present disclosure is generally directed to the fields of communications and in particular to methods, architectures, apparatuses, systems directed to energy-aware UE-to-network relaying services.

### SUMMARY

In a first aspect, the present principles are directed to a method at a relay device, the method including establishing a connection with a remote device, monitoring energy consumption related to data traffic forwarded through the relay device for the remote device, and, in response to detecting an energy-related event affecting an ability of the relay device to respect an energy criterion negotiated with the remote device, sending, to the remote device, information indicative of a request to alter the connection, and altering the connection.

In embodiments, the data traffic forwarded through the relay device for the remote device includes at least one of data traffic originating at the remote device forwarded to a network and data traffic received from the network forwarded towards the remote device.

In embodiments, the method includes providing, to the remote device, energy-related information indicative of energy consumption related to data traffic transmission through the relay device.

In embodiments, the connection with the remote device is established via at least one intermediate relay device.

In embodiments, the connection is altered upon reception of information, received from the remote device, indicative of a response to the request.

In embodiments, the information indicative of the request to alter the connection is a link modification request or a link release request.

In embodiments, the energy criterion is negotiated during a discovery procedure involving the relay device and the remote UE.

In embodiments, the method includes, while the ability of the relay device to respect the energy criterion is affected, at least one of refraining from sending announcement messages and refraining from responding to discovery solicitation messages.

In embodiments, the method includes reporting energy usage of the relay device to a further entity, and receiving from the further entity an estimate of energy usage of the data traffic forwarded through the relay device for the remote device, the estimate based on at least the reported energy usage of the relay device.

In embodiments, the energy-related event affecting the ability of the relay device to respect an energy criterion is related to monitored energy usage attaining or exceeding a value agreed with the remote device.

In a second aspect, the present principles are directed to a relay device including at least one processor configured to establish a connection with a remote device, monitor energy consumption related to data traffic forwarded through the relay device for the remote device, and, in response to detecting an energy-related event affecting an ability of the relay device to respect an energy criterion negotiated with the remote device, send, to the remote device, information indicative of a request to alter the connection, and alter the connection.

In embodiments, the data traffic forwarded through the relay device for the remote device includes at least one of data traffic originating at the remote device forwarded to a network and data traffic received from the network forwarded towards the remote device.

In embodiments, the at least one processor is configured to provide, to the remote device, energy-related information indicative of energy consumption related to data traffic transmission through the relay device.

In embodiments, the at least one processor is configured to establish the connection with the remote device via at least one intermediate relay device.

In embodiments, the at least one processor is configured to alter the connection upon reception of information, received from the remote device, indicative of a response to the request.

In embodiments, the information indicative of the request to alter the connection is a link modification request or a link release request.

In embodiments, the energy criterion is negotiated during a discovery procedure involving the relay device and the remote UE.

In embodiments, the at least one processor is configured to, while the ability of the relay device to respect the energy criterion is affected, at least one of refrain from sending announcement messages and refrain from responding to discovery solicitation messages.

In embodiments, the at least one processor is configured to report energy usage of the relay device to a further entity, and receive from the further entity an estimate of energy usage of the data traffic forwarded through the relay device for the remote device, the estimate based on at least the reported energy usage of the relay device.

In embodiments, the energy-related event affecting the ability of the relay device to respect an energy criterion is related to monitored energy usage attaining or exceeding a value agreed with the remote device.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a method of Model A U2N Relay direct discovery and selection using energy saving assistance information according to the present principles;

FIG. 3 illustrates a method of Model B U2N Relay direct discovery and selection using energy saving assistance information according to the present principles; and

FIG. 4 illustrates an example method according to an embodiment of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

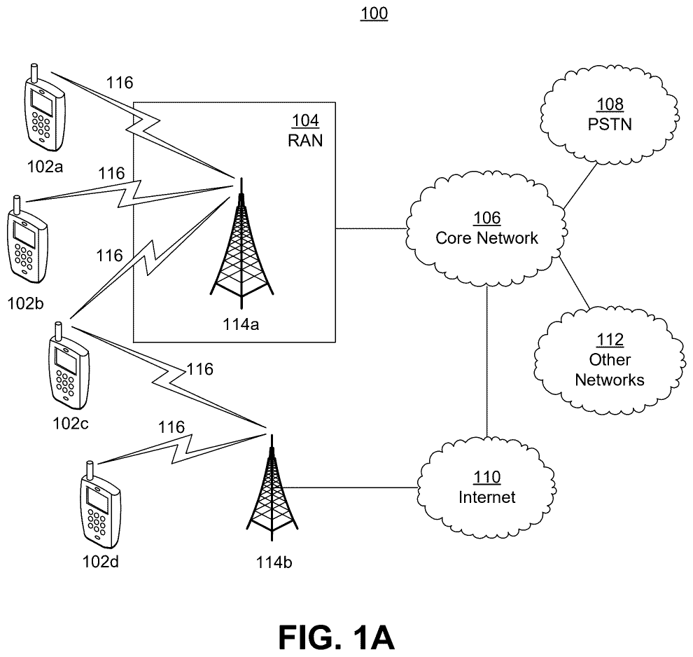

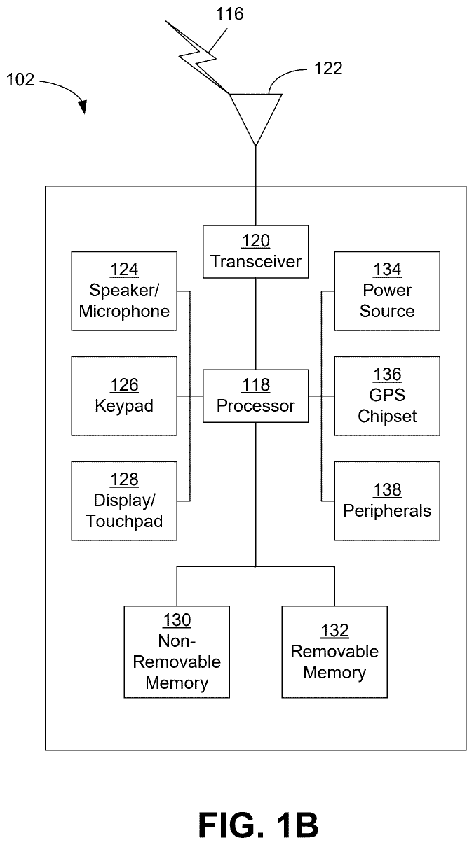

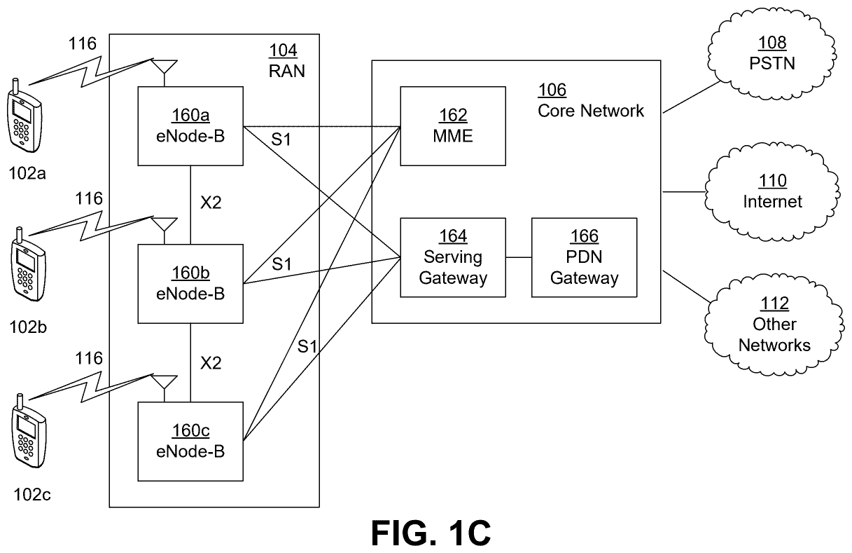

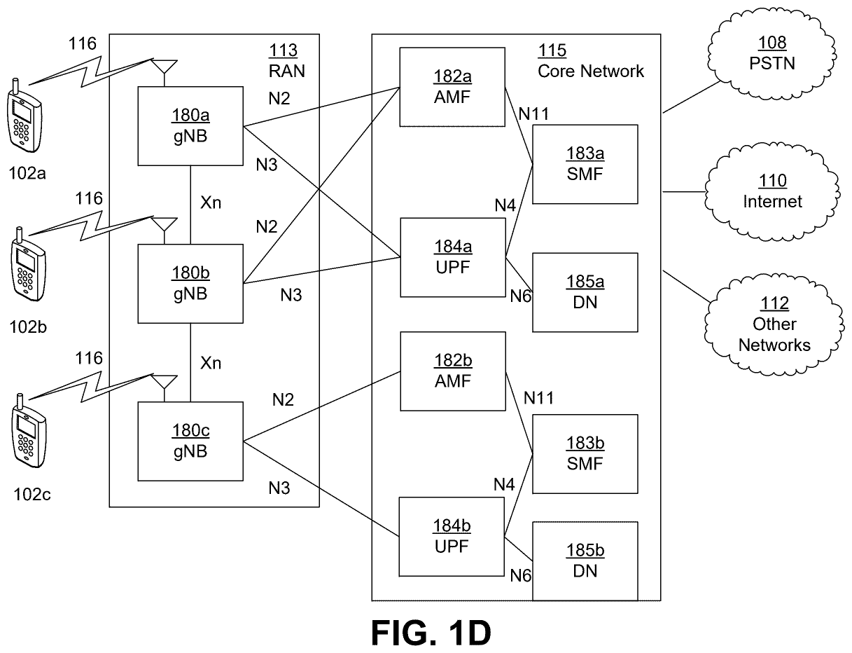

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire (i.e. obtain) location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

U2N Relay discovery and communication for Proximity-based Services (ProSe) is defined in 5 G Rel-17 (see TS 23.304, Proximity based Services (ProSe) in the 5G System (5GS); Stage 2; V 19.3.0, and TS 24.554, Proximity-services (ProSe) in 5G System (5GS) protocol aspects; Stage 3; V 19.1.0). Relay discovery and connection by a Remote UE via a PC5 link uses a provisioned Relay Service Code (RSC) associated with Data Network Name/Single Network Slice Selection Assistance Information (DNN/S-NSSAI). The Relay provides a Protocol Data Unit (PDU) Session for the connected Remote UE.

To support ProSe direct discovery, a ProSe-enabled UE is provided with a discovery policy and parameters to support the discovery role. The policy and parameters include an authorization policy for ProSe direct discovery, which lists the PLMNs in which the UE is authorized to perform discovery. The authorization policy list can be different depending on whether the discovery uses so-called Model A or Model B. The list can be different depending on whether the UE is performing open or restricted ProSe discovery. The list can also be different depending on the role the UE plays during the discovery (on the receiving end or the sending end of the discovery message).

The policy and parameters may also include ProSe discovery UE ID, for restricted direct discovery.

The policy and parameters also include a validity timer indicating the expiry of the policy/parameters for the direct discovery.

Similarly, to support ProSe direct communication, a ProSe-enabled UE is also configured with specific provisioning information. The provisioning information includes policy and parameters similar to the discovery policy and parameters, such as for example direct communication authorization policy. The provisioning information additionally includes policy and parameters including mapping of ProSe service (ProSe identifiers) to default destination layer 2 ID for initial signalling to establish a unicast connection, mapping of ProSe services (ProSe identifiers) to PC5 Quality of Service (QOS) parameters (PC5 5QI (PQI) and potentially other parameters such as Maximum Flow Bit Rate (MFBR)/Guaranteed Flow Bit Rate (GFBR). The provisioning information also includes a validity timer to indicate the expiration time of the policy/ and parameters for the direct communication.

For a ProSe-enabled UE to support the role of a UE-to-Network (U2N) Relay, it may be provisioned with various information. The provisioning information supporting the U2N relay role may include an authorization policy indicating which Public Land Mobile Networks (PLMNs) the UE is authorized to use to relay traffic. The authorization may be provided for the layer 3 Relay U2N Relay or layer 2 U2N Relay roles.

The provisioning information supporting the U2N relay role may include ProSe relay discovery policy/parameters. These parameters may include relay service code(s) (RSCs), user info ID, an indication of the layer (layer 2 or 3) for the relay to support per RSC. The parameters may also include a destination layer 2 ID for the signalling messages (discovery announcement and additional information messages and receiving discovery solicitation messages).

Furthermore, for a layer 3 U2N Relay, the parameters may include, for each RSC, PDU session parameters, such as PDU session type, DNN, value, S-NSSAI value, Session and Service Continuity (SSC) mode, access type preference.

The provisioning information may further include for a layer 3 U2N Relay, QoS mappings, where, for each QoS mapping entry, there is a mapping between a 5QI value and a PQI value, a PQI Packet Delay Budget (PDB) adjustment factor for the relaying operation, and optionally the RSCs associated with the QOS mapping entry.

The provisioning policy/parameters include a validity time that indicates the expiration time of the policy for the U2N Relay for discovery and communication.

In parallel, energy efficiency and saving was studied in TR 23.700-66, Study on Energy Efficiency and Energy Saving; V 19.0.0 in 3 GPP SA 2 working group, and is currently studied in a phase 2 study (see SP-250401, New SID on Study on Stage 2 for Integrated Sensing and Communication).

The conclusion of the study in TR 23.700-66 was that a focus on user plane related energy considerations is to be considered. One of the key aspects that is being discussed is how to leverage energy information related to the user plane traffic exchanged between a UE and an application server, to determine the most energy efficient or least energy consuming user plane path for the UE.

It will be appreciated that when a ProSe-enabled UE can leverage ProSe capabilities to exchange data traffic, in particular using U2N Relay, the energy consumption/efficiency aspects related to the traffic exchange between the (remote UE) and the U2N Relay become relevant and an important factor to consider, since the U2N Relay is relaying/forwarding user plane traffic. However, so far, the 5GS does not consider energy cost related to U2N Relay for communications services involving UE to network relays.

According to the present principles, a ProSe-enabled UEs, for the role of U2N Relay or the role of remote UE, can be provisioned with information pertaining to the capability of a U2N Relay to be aware of the energy consumption/usage for relaying traffic of a remote UE with the 5GS.

Further according to the present principles, U2N Relays may be discovered and selected by remote UEs, using energy consumption/usage related information, whether using direct discovery Model A or direct discovery Model B.

Further according to the present principles, a U2N Relay may be configured for and perform energy usage calculations, monitoring, reporting and control in order to provide a relaying service that takes energy aspects into consideration.

In a first embodiment of the present principles, for the role of U2N Relay or the role of remote UE, a Prose-enabled UE is provisioned and configured with energy consumption/savings information.

As already described, a ProSe-enabled UE for U2N Relay role is provisioned/configured by the 5GS with information for ProSe direct discovery and communication policies/parameters. In the first embodiment, the U2N Relay is also provided with information related to energy consumption/saving.

The U2N Relay can be configured with capabilities/policies/parameters to support energy saving operations, which will be referred to as Energy Saving Assistance information.

The U2N Relay may be configured to support energy saving for the relaying operation. The support can be represented by information indicating whether the U2N Relay supports energy saving for relaying purposes.

The U2N Relay may further be configured with different modes of energy savings.

As a first, the U2N Relay may be configured to support a balanced energy saving mode in which the U2N Relay may support both relaying remote UE traffic with a certain QoS while trying to reduce (e.g. minimize) the energy consumption of the data session that is relayed for the remote UE.

As a second example, the U2N Relay may be configured to support a strict energy saving mode in which the U2N Relay may stop relaying traffic for a remote UE if the energy consumption/usage for that traffic exceeds a given value (i.e. is above a threshold).

As a third example, the U2N Relay may be configured to support an “energy-first-QoS-second” energy saving mode in which the U2N first makes sure the energy consumption of a certain traffic session with the UE does not exceed a certain threshold and then tries to increase (e.g. maximize) the QoS for the remote UE. This resembles a best effort QoS, where energy saving is prioritized first over the QoS.

In an example, when the U2N Relay device is a mobile phone or a similar device that is battery equipped, the U2N Relay in this case has an energy source that can be considered not green.

The U2N Relay that is powered by a renewable source of energy, may have an attribute of being a green-powered U2N Relay. Such a U2N may be configured with relaxed requirements such that the U2N could facilitate remote UEs with the energy savings, e.g., allow them to adopt longer down periods, while the green U2N may be able to stay up for a longer duration.

The U2N Relay may be provisioned with a maximum energy consumption parameter. A maximum energy consumption per remote UE represents the maximum energy consumption or usage that is spent or used to relay the remote UE traffic by the U2N Relay.

The U2N Relay may be provisioned with an aggregated maximum energy, which is the highest energy consumption that can be used by the U2N Relay for relaying all Remote UEs that have a traffic session relayed by the U2N Relay. The U2N Relay may be provisioned with different aggregated maximum energy requirements based on the type of energy source, e.g., battery equipped, power by a renewable energy source, power by a non-green energy-source etc.

The U2N Relay may be provisioned with an energy usage threshold per RSC value. This value represents the maximum amount of energy the U2N Relay can use to relay traffic related to the RSC in question.

Additionally, there can be a priority value per RSC relating to energy. In an example, when the overall energy usage by the U2N relay exceeds a given value, then, based on the per RSC (energy related) priority, the U2N Relay may determine, based on respective priority values, that certain RSCs are not to be served while it can serve other RSCs as long as the energy usage for the served RSCs does not exceed their respective thresholds.

In case a maximum energy value is reached, e.g. for a RSC value or overall, a U2N Relay may trigger a link release procedure for the associated Remote UEs. The reason for link release may be indicated, e.g., U2N Relay unavailable or maximum energy threshold reached. Then the U2N no longer serves as a U2N Relay for a specific period of time, e.g., configured with an inactivity timer that is started when the maximum energy value is reached.

A U2N Relay may be provisioned with values (e.g. thresholds) to ensure a minimum energy efficiency for relaying the traffic related to the Remote UE. In this case, the U2N Relay may have a minimum value for energy efficiency to satisfy for a given traffic of interest. This value can be per remote UE, per RSC, or a parameter for the U2N Relay.

The energy usage/consumption characteristic can be interpreted as an average energy consumption over a given time window. In an alternative, the energy consumption characteristic can reflect the energy consumed for a complete data session of the remote UE, for a certain RSC (e.g., for the duration of the data session and its forwarding).

The energy usage/consumption characteristic can represent an average energy consumption over the number of remote UEs that are connected to the U2N Relay (potentially in a given time window). In case multi-hop U2N Relay is considered, then the energy consumption characteristic can represent an average energy consumption over the number of remote UEs, number of intermediate relays or all the UEs that are connect to the U2N Relay for a specific RSC within a time window.

A U2N Relay may be configured to be able to measure/monitor and report energy usage related information. The U2N Relay may be configured to measure or calculate the energy consumption related to relaying data traffic for a certain granularity (e.g., a certain remote UE, a certain RSC, a group of remote UEs, aggregated energy used, or over a given time window). For this purpose, the U2N Relay may be provided with a template to be used to estimate/determine the energy consumed for relaying certain data traffic. The template may include parameters provided by the 5GS to assist the U2N Relay to calculate the energy consumption for the traffic of interest.

For example, the template may indicate that the energy consumption at the U2N Relay has a static component that is related to the U2N Relay being powered on, and provides this static energy consumption value (e.g., energy consumption for powered on U2N Relay per second).

The template may also include a dynamic energy consumption component, which may depend on the data volume/data rate of the traffic that is being relayed by the U2N Relay. The U2N Relay may be provided with a parameter that is multiplied by the data volume relayed by the U2N Relay. Other parameters and attributes may also be included in the energy calculation template. This first approach allows the U2N Relay to calculate locally an energy consumption estimate, without requiring the 5GS to perform the calculation for the U2N Relay.

The template may include respective information for UL traffic relaying and for DL traffic relaying.

In a second approach, the U2N Relay may be configured to report to the 5GS data usage information for the traffic session of interest. This can include data volume used to relay given traffic, the data rate, on time (when the U2N Relay has traffic relayed) and off time (when the relay did not have any traffic to relay for a certain period of time), and so on. The U2N Relay may be configured to report such information for different granularities, such as per remote UE, per RSC or aggregated, and that may depend on the RSC of interest. For example, the U2N Relay may be configured to calculate energy usage or report energy related usage only for certain RSCs.

The U2N Relay may be configured with the address of the network entity to which the U2N Relay needs to report the energy related information.

The U2N Relay may be configured with an energy savings rating. The energy saving rating may be a scalar value, indicating how good the energy saving performance of the U2N Relay is. The energy saving rating may take into consideration multiple factors that the 5GS may use to determine the rating. This may include past performance, energy characteristics of the U2N Relay, and predictions of U2N Relay in certain areas and time of the day. Additionally, the energy saving rating of a U2N Relay may consider the percentage of renewable energy that is used by the U2N Relay from the total energy source that the U2N Relay is using. The energy consumption/savings rating can be associated with the RSCs that the U2N Relay supports. Each RSC may have an associated energy savings rating, for example, a scalar indicating whether the rating is low, medium or high.

The energy consumption/savings rating related to an RSC or related to a U2N Relay may be updated during U2N Relay policy configuration to reflect network energy optimization or local serving (e.g., network source of energy).

Similarly, a ProSe-enabled UE for the remote UE role is provisioned/configured by the 5GS with information for ProSe direct discovery and communication policies/parameters. The provisioning information for the remote UE includes already described conventional information.

In addition to conventional policy and parameters provisioned for the Remote UE for ProSe direct discovery and direct communication, the remote UE may further be configured with supported RSCs that require energy monitoring and control, meaning that there may be energy usage/consumption/efficiency requirements related to traffic related to the RSC of interest.

The remote UE may be configured with RSCs for which energy saving is preferred. The remote UE may be further configured with the energy saving mode that is preferred/required for these RSCs.

The remote UE may be provisioned with information indicating, for given RSCs, that energy consumption monitoring and reporting is required for these RSCs. The remote UE may use this information to discover and select U2N Relays that support energy consumption calculation/monitoring/reporting and control.

The remote UE may be provisioned with values for maximum energy consumption (or similarly minimum energy efficiency) to be used in relation to a specific RSC, in a certain period of time, or during the duration of a data session.

The present principles provide a procedure for ProSe direct discovery between a Remote UE and a U2N Relay that considers energy related aspects, using Model A for direct discovery.

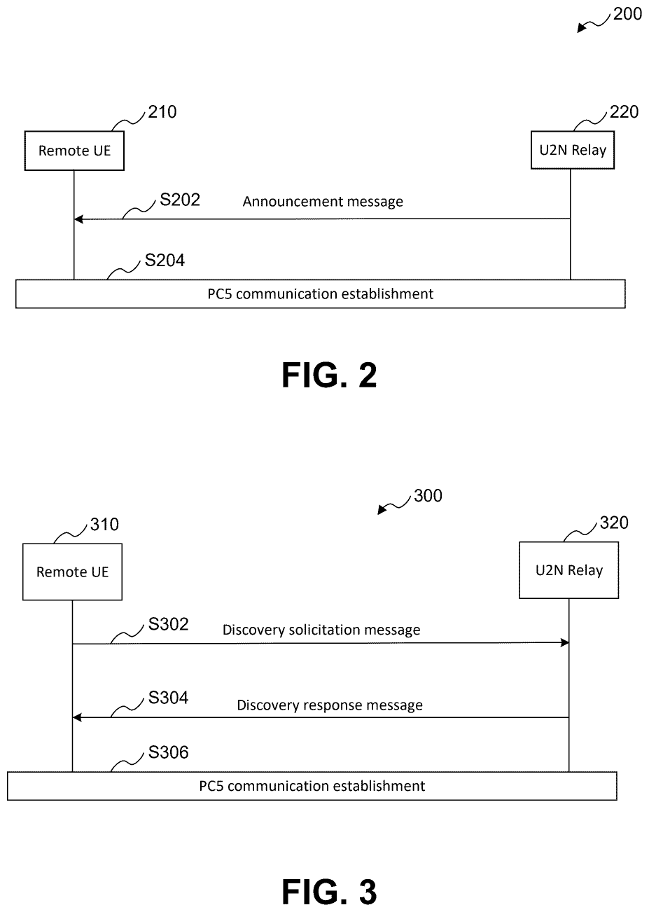

FIG. 2 illustrates a method of Model A U2N Relay direct discovery and selection using energy saving assistance information according to the present principles.

In the method 200 of ProSe direct discovery using Model A, a U2N Relay 220 sends, in step S202, an announcement message, which is a broadcast message to announce its presence and offer its services.

The announcement message includes the already described energy related assistance information that the U2N Relay is provisioned with. The energy related assistance information can include supported RSCs and an indication whether the U2N Relay supports energy aware relaying/energy savings. The energy related assistance information can also include one or more of the RSCs for which it supports energy savings, RSCs subject to energy usage monitoring and control, information indicative of support for energy related monitoring and control for given RSCs, which may include a value for energy consumption/usage, where the value for example may indicate the maximum amount of energy consumption/usage for simultaneously connected remote UEs, and where the value may be different for different RSC values.

In a variant, the announcement message may include an “energy budget” parameter that can be used for a specific RSC. The U2N Relay may use the energy budget together with a priority value per RSC as follows. When the energy consumption for the U2N Relay related to the RSC of interest is below the energy budget value for that RSC, then the U2N Relay may continue to relay traffic related to the RSC of interest. When the energy consumption of the U2N Relay related to the RSC of interest reaches or exceeds the energy budget value for that RSC, then the U2N Relay may use the priority value of the RSC and the other RSCs to determine whether to keep relaying traffic specific to the RSCs.

The announcement message may include the energy consumption/savings rating of the U2N Relay.

A Remote UE 210 monitors for announcement message(s) from U2N Relay(s).

In case of multi-hop U2N Relay, there can be one or more intermediate U2N Relay UEs between the Remote UE 210 and the U2N Relay 220, which enables multi-hop communication therebetween. The U2N Relay 220 may be configured with an overall energy budget for the discovery mechanism for the multi-hop case, which is provided in the announcement message.

The remote UE 210 receives from the U2N Relay 220, possibly via one or more intermediate U2N Relay UEs, the announcement message that includes advertised RSCs and energy consumption/saving related information.

The remote UE 210 may consider the energy consumption/saving related information received from the U2N Relay to determine whether to establish, in step S204, a direct link with the U2N Relay 220.

For example, if the U2N Relay 220 has indicated that it supports an energy saving mode where the energy consumption is minimized and the QoS can be highly degraded, then the remote UE 210 may decide not the establish a PC5 link with the U2N Relay and instead try to discover other U2N Relays.

In case the remote UE 210 receives more than one announcement message from different U2N Relays, then the remote UE may select a given U2N with which to establish, in step S204, a PC5 link based on energy related aspects.

For example, if two U2N Relays support the desired energy saving mode (e.g., balanced energy saving mode) and a first U2N Relay has an energy consumption/savings rating R1 that is higher than a energy consumption/savings rating R2 of a second U2N Relay, then the remote UE 210 may decide to connect with the first U2N Relay.

Alternatively, if the energy savings rating associated with the RSCs supported by the U2N Relays, then the remote UE 210 may select RSC/U2N Relay based on the energy rating, for example, in case the remote UE 210 has received information about two RSCs, RSC-a and RSC-b, respectively supported by the first U2N Relay and the second U2N Relay. If the two RSCs provide a similar service, for example being associated with the same S-NSSAI/DNN values, then the remote UE 210 may select the RSC with the highest energy saving rating. If for example RSC-a and RSC-b offer the same service, and RSC-a has a higher energy rating than RSC-b, then the remote UE 210 may select to use RSC-a, and since U2N Relay1 offer RSC-a, then the remote UE 210 selects U2N Relay1 with which to establish a communication link in step S204.

To select the U2N Relay, the remote UE 210 may take into consideration other aspects, such as maximum data rate per remote UE or per RSC per remote UE that the U2N Relays support, or the maximum energy consumption supported per remote UE per RSC.

There can be other aspects related to link quality for the link between the remote UE and potential U2N Relay, for example transmission delay (i.e. the time it takes a packet to go from the remote UE to the U2N Relay, and vice versa) and guaranteed data rate or available bandwidth for the link between the remote UE and U2N Relay.

The remote UE 210 may use information received from the U2N Relay related to energy aspects to determine the parameters related to the link quality to select and use to determine whether the U2N Relay can fulfil the parameters.

For example, the remote UE 210 may have an association between values or range of values of data rate to be used for the communication with the U2N Relay, with relative estimates of the energy consumption that can be incurred from using the data rates. The remote UE 210 may have information that indicates that for a data rate between 5 Mbps and 10 Mbps, the energy consumption is between 5 J and 10 J per time unit, and for a data rate between 10 Mbps and 20 Mbps, the energy consumption is estimated to be between 10 J and 15 J per time unit. In case the remote UE 210 is provided with a maximum energy consumption budget in the advertisement message from the U2N Relay 220 and the value of the maximum energy budget or maximum energy to be used per time unit is 10 J per time unit, then the remote UE 210 may determine that to be able to remain below 10 J per unit, the highest data rate it needs to support for the data exchanged with the U2N Relay 220 for the traffic of interest (e.g., for an RSC), should not exceed 10 Mbps. The remote UE 210 may determine that the U2N Relay 220 is not suitable for remote UE communication because the required remote UE data rate is around 15 Mbps, in which case the energy consumption using this data rate would exceed the energy budget offered by the U2N Relay (of 10 J).

The remote UE 210 may be provided with energy related values that indicate the guaranteed energy budget that the U2N is able to offer for relaying the traffic of interest with the remote UE 210 for a certain RSC value, and the maximum energy level/budget the U2N Relay can offer to relay traffic across different RSCs.

The remote UE 210 may use the guaranteed energy budget provided by the U2N Relay 220 to determine an estimate of the guaranteed data rate that can be used by the remote UE 210 for the RSC of interest, to be relayed by the U2N Relay 220.

The remote UE 210 may use the maximum energy level that can be offered by the U2N Relay 220 to relay the remote UE traffic across different RSCs, to determine an estimate of the maximum data rate value, which can be a per RSC maximum data rate parameters or an aggregated maximum data rate parameter.

The remote UE 210 may use the determined estimated values of data rate to determine the values of data rate it can use with the energy budget provided by the U2N Relay 220, and to determine whether the U2N Relay 220 is suitable for the remote UE service requirements.

The remote UE 210 may use both energy related information, e.g., energy budget information, and other parameters such as delay parameters that can be provided by the U2N Relay 220 or that the remote UE 210 expects for the traffic of interest to endure to determine data rate thresholds, e.g., maximum data rate, or guaranteed data rate/available bandwidth.

The remote UE 210 may convert the maximum energy consumption capacity the U2N Relay 220 is able to support for the remote UE 210 to a channel quality or a distance between U2N Relay and Remote UE attributes, and then use these attributes to decide whether the U2N Relay 220 is a good candidate to relay data traffic for the remote UE 210.

As mentioned, once the remote UE 210 determines that a U2N Relay 220 is suitable to serve the remote UE for relaying, in step S204, it performs a PC5 link establishment procedure with the selected U2N Relay 220.

FIG. 3 illustrates a method of Model B U2N Relay direct discovery and selection using energy saving assistance information according to the present principles.

In the method 300 of ProSe direct discovery using Model B, in step S302, a remote UE 310 sends a discovery solicitation message. The discovery solicitation message is broadcast to help discover nearby ProSe-enabled UEs.

The solicitation message includes one or more RSC codes that the remote UE 310 is interest to have supported. The remote UE 310 indicates that it is looking for a U2N Relay 320 to help relay remote UE data traffic.

The solicitation message further includes information related to desired energy savings characteristics. The solicitation message may include an indication that the remote UE 310 is searching for a U2N Relay that supports energy savings relaying operations.

The solicitation message may further include a set of desired RSCs that require energy savings when relayed by the U2N Relay 320.

The solicitation message may include a requested energy saving mode for the remote UE traffic, and additionally for each RSC requiring energy savings.

The solicitation message may include an energy consumption requirement provided by the remote UE 310.

For example, the solicitation message may include a value for the maximum energy consumption that can be used by the U2N Relay 320 to relay data traffic for the remote UE 310. This maximum energy consumption value, which may be provided per RSC requiring energy savings/aware relaying, may be a maximum energy consumption in a certain window of time.

For different RSC values, the solicitation message may provide different thresholds on the maximum energy consumption to be used to relay traffic related to the specific RSC value.

Similarly, the solicitation message may include a requirement for the minimum energy efficiency that needs to be provided to relay remote UE data traffic of interest.

The solicitation message may include an indication that energy monitoring and reporting is needed for certain data traffic and may indicate the RSC values for which the U2N Relay 320 needs to monitor and report energy consumption.

The solicitation message may include an indication about the percentage of the energy consumed by the U2N Relay 320 for relaying purposes originating from a green or renewable energy source. For example, the remote UE 310 may indicate that the U2N Relay 320 is to use a renewable energy source for at least 50% of its relaying operations (e.g., for the remote UE, or for all UEs).

The solicitation message may indicate a certain required/preferred energy consumption/savings rating that the remote UE 310 is looking for from the RSC or the U2N Relay 320 to relay the traffic of interest.

As in the description of FIG. 2, it will be understood that one or more intermediate U2N Relay UE may be located between the remote UE 310 and the U2N Relay 320.

Having received the solicitation message form the remote UE 310 in step S302, in step S304, the U2N Relay 320 replies to the remote UE 310 with a discovery response message. In this message, the U2N Relay 320 may include a list of RSCs, from those requested by the remote UE 310, that are supported by the U2N Relay 320.

Furthermore, the U2N Relay 320 may indicate whether it supports energy saving relaying operations as well as information indicative of these operations.

The discovery response message may include provided energy saving modes and the corresponding granularities (e.g., whether the energy saving modes are for the remote UE, or for specific RSCs). The U2N Relay 320 may include its energy consumption/savings rating with corresponding granularities.

The U2N Relay 320 may indicate the maximum achievable energy efficiency level it can provide to the remote UE 310 for relaying the traffic of interest. The U2N Relay 320 may include the minimum energy consumption incurred by relaying the traffic of interest for the remote UE 310.

Similarly to the discovery procedure for Model A, when the remote UE 310 receives the discovery response message from a U2N Relay 320, it can determine whether the U2N Relay 320 is suitable to relay remote UE traffic (or whether to search for another U2N Relay).

The remote UE 310 may for example check whether the energy saving mode(s) the U2N Relay 320 supports is acceptable to serve the remote UE traffic. Additionally, to determine whether the U2N Relay is suitable, the remote UE 310 can check the minimum energy consumption or maximum energy efficiency the U2N Relay 320 may provide for the remote UE traffic.

For example, if the U2N Relay 320 indicated that relaying remote UE traffic will incur at least 10 Joules in a certain time window and the remote UE 310 requested an energy consumption not more than 6 J in the time window, then the remote UE 310 may determine that the energy consumption of the U2N Relay 320 is relatively high compared to the energy consumption budget the remote UE intends for the traffic of interest.

Alternatively, as an example, the remote UE 310 may have indicated that it requires the U2N Relay 320 to reserve some energy resources to relay the traffic of interest, and that the energy required to be reserved is 20 J for a duration of 5 minutes. In case the U2N Relay 320 then replies to the remote UE 310 indicating that the maximum energy resource it can allocate for the remote UE traffic of interest is only 13 J for a duration of 5 minutes, then the remote UE 310 may consider the U2N Relay 320 as unsuitable to relay remote UE traffic of interest.

The U2N Relay 320 may indicate the time window during which it can relay remote UE data traffic. This attribute can be a per remote UE per RSC attribute, or a per RSC attribute. The U2N Relay 320 may update or provide the available energy capacity per RSC for the remote UE 310 (e.g., when other remote UEs are also using this RSC with the U2N Relay simultaneously).

To be able to serve the remote UE 310 and relay remote UE traffic, there may be a QoS requirement for the PC5 link between the remote UE 310 and the U2N Relay 320, and a QoS requirement for the link between the U2N Relay 320 and the 5GS (not shown). Similarly, to be able to relay remote UE traffic, there may be an energy consumption/usage requirement between the remote UE 310 and U2N Relay 320 and an energy consumption/usage requirement between the U2N Relay 320 and the 5GS.

The energy budget per RSC may be considered by the remote UE 310 when selecting the U2N Relay that relative to a QoS requirement. Even when there is no QoS requirement (e.g. Best Effort service), the remote UE 310 may still select a U2N Relay 320 with the best link quality (among available U2N Relays) and the best energy budget provided it satisfies the requested energy efficient level.

In an example, there may be a first QoS requirement PQI1 between the remote UE 310 and the U2N Relay 320, and a first energy consumption threshold MaxEn1 in a certain time window. Additionally, there may be a second QoS requirement PQI2 between the U2N Relay 320 and the 5GS and a second energy consumption threshold/requirement MaxEn2 between the U2N Relay 320 and the 5GS. In an example, there may be accumulated QoS requirements for the multi-hop U2N Relay, for the multi-hop U2N Relay that is used for discovery and establishment of a multi-hop link via one or more intermediate U2N Relay UEs. There may also be an indication, based on the maximum energy requirements, whether multi-hop communication is enabled or disabled.

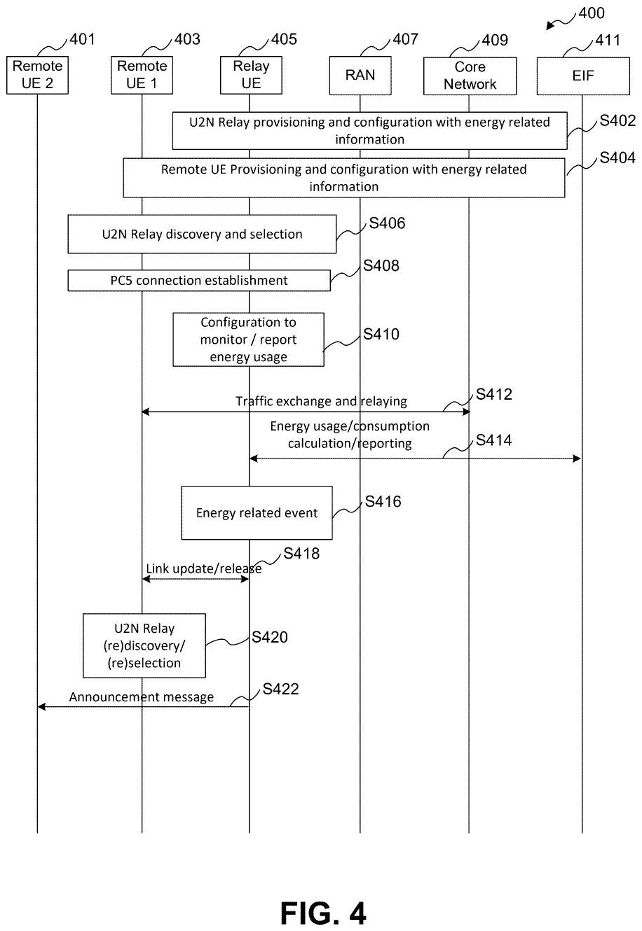

FIG. 4 illustrates an example method according to an embodiment of the present principles.

The illustrated method is for provisioning a remote UE and a U2N Relay with energy awareness, and energy-aware U2N Relay discovery and selection. It will also be described how a U2N Relay calculates, monitors and reports energy related information, and how this energy related information can be used by the U2N Relay, 5GS, or remote UE to better serve the remote UE.

In step S402, a Relay UE 405 receives information indicative of policy/parameters for ProSe including energy related information, as already described, and is configured based on this information.

In step S404, a first remote UE 403 receives information indicative of policy/parameters for ProSe including energy related information, as already described, and is configured based on this information.

In step S406, the first remote UE 403 and the U2N Relay 405 perform energy aware U2N discovery and selection using model A, as described with reference to FIG. 2, or using model B, as described with reference to FIG. 3.

In step S408, the first remote UE 403 and the U2N Relay 405 establish a PC5 link communication, as described with reference to FIG. 2 and FIG. 3. The first remote UE 403 is then able to exchange data traffic with the core network 409 via the U2N Relay 405 and the Radio Access Network (RAN) 407.

In step S410, the U2N Relay 405 is configured to monitor energy usage related to the data session with the first remote UE 403.

The U2N Relay 405 may be configured to measure/estimate the energy consumption related to relaying the data traffic with the first remote UE 403. The U2N Relay 405 may use the template provided by the core network 409 during the provisioning in step S402 to determine the method and parameters to calculate the energy consumption for the link of interest.

The U2N Relay 405 may also have negotiated additional parameters related to the energy usage monitoring with the first remote UE 403. For example, the first remote UE 403 may negotiate with the U2N Relay 405 that the U2N Relay 405 is to report energy events to the first remote UE 403. The U2N Relay 405 may send a notification to the first remote UE 403 in case the energy usage has exceeded a certain threshold agreed upon with between the first remote UE 403 and the U2N Relay 405. The U2N Relay 405 may report to the first remote UE 403 a status of the energy efficiency measured or estimated for the link between the first remote UE 403 and the U2N Relay 405.

The U2N Relay 405 may report energy consumption related to information to the core network 409. The U2N Relay 405 may be configured to send a report to the core network 409, e.g., via the user plane (e.g., to a User Plane Function (UPF), not shown), or via the control plane (e.g., to a Session Management Function (SMF), not shown, an Energy Information Function (EIF) 411, and a Network Data Analysis Function (NWDAF), not shown) to report an estimate of the energy usage related to the relaying traffic related to the first remote UE 403. This can include traffic exchanged between the first remote UE 403 and the U2N Relay 405 to be relayed by the U2N Relay 405, and traffic exchanged between the core network 409 and the U2N Relay 405, to be relayed to the first remote UE 403.

The U2N Relay 405 may be configured to interact with the core network 409, for example the EIF 411, to have a more complete estimate of the energy consumption or energy efficiency relate to relaying the data traffic of the first remote UE 403. For example, the U2N Relay 405 calculates the data volume of the traffic for the first remote UE 403 that is relayed by the U2N Relay 405 and sends a data volume report to the EIF 411, and in turn the EIF 411 can determine an estimate of the energy usage/efficiency for the U2N Relay 405 related to relaying traffic of the remote UE of interest. It is noted that the EIF 411 can be part of the core network 409 and that it is illustrated as a separate entity for illustrative purposes.

The U2N Relay 405, the core network 409, and the first remote UE 403 may agree on parameters related to reporting, such as reporting period and reporting threshold(s).

In step S412, user plane traffic is exchanged between the first remote UE 403 and an entity such as an application server via the UPF in the core network 409. The data traffic is relayed by the U2N Relay 405 via the PC5 link established with the first remote UE 403 in step S408.

In step S414, the U2N Relay 405 monitors and calculates energy usage related to the traffic relayed for the first remote UE 403.

For example, the U2N Relay 405 can be configured to estimate/determine the energy consumption/usage locally, using for example a template provided by the core network 409. In this case, the U2N Relay 405 may report energy related information to the core network 409 but can also refrain from doing so depending on the configuration.

For example, the U2N Relay 405 can communicate with the EIF 411 (or other core network 409 node) to determine the energy consumption related to the traffic of interest. To this end, the U2N Relay 405 can perform a local calculation related to energy usage or data usage (e.g., data volume), related to the traffic of interest and send this information to the EIF 411. The EIF 411 can use the information received from the U2N Relay 405 to determine a more complete estimation of the energy usage information for the traffic of interest. The EIF 411 can send its estimation to the U2N Relay 405.

The EIF 411 may determine energy related information on different granularities for the U2N Relay 405. For example, the EIF 411 may determine energy usage related to the RSC of interest for the first remote UE 403 of interest relayed by the U2N Relay 405.

The EIF 411 may determine the energy usage at the U2N Relay 405 related to the RSC, for all the remote UEs connected to the U2N Relay 405 that exchange traffic for the RSC of interest (e.g., on a RSC level, for any remote UE).

The EIF 411 may estimate the energy usage for the U2N Relay 405 across different RSCs and for different remote UEs (e.g., on a U2N Relay level). The core network 409 may use this information to update or reconfigure the U2N Relay 405, e.g., to limit the energy capacity per remote UE for the U2N Relay 405.

The energy-related aspects may be used by the core network 409, e.g., the EIF 411 and the Policy Control Function (PCF), to assess and perhaps update energy savings rating for the RSCs of interest for the U2N Relay 405.

The U2N Relay 405 may also exchange with the core network information related to the energy source for the U2N Relay 405, e.g., how much green or renewable energy is being used for the U2N Relay service of the total energy consumed by the U2N Relay 405 (e.g., including renewable and non-renewable energy source).

In step S416, an energy related event is detected at the U2N Relay 405.

The energy related event may indicate that the energy usage/consumption for the data session between the first remote UE 403 and the U2N Relay 405 has exceeded a given energy usage value (i.e. threshold). This can reflect energy usage during a certain period or cumulated energy usage for the traffic of interest since the start of the traffic exchange in step S412.

Additionally, when a plurality of remote UEs are attached/connected to the U2N Relay 405 and its energy consumption exceeds a value, the U2N Relay 405 may determine to drop the connection with one or more remote UEs based on the remote UE's respective QoS requirement or energy consumption requirement or per NW's configuration (e.g. based on a priority per remote UE and/or per RSC).

The energy-related event may indicate that the energy efficiency for relaying the remote UE traffic for the traffic of interest is beyond a certain level (e.g., it has degraded).

The energy-related event may be related to estimated energy usage for the U2N Relay 405, either for UL, DL, or total traffic for the remote UE of interest.

In response to the detection of the energy-related event, different actions may be performed for the U2N Relay operation.

In an example, the U2N Relay 405 may have detected that the energy usage for relaying the traffic of interest for the first remote UE 403 for a certain period of time has exceeded a certain threshold, or the related energy efficiency has decreased below as certain level.

The U2N Relay 405 may determine that parameters related to the traffic of interest may need to change. For example, it may determine that the data rate between the U2N Relay 405 and the first remote UE 403 need to be decreased so that the energy usage per time period goes below a given value.

In another example, to maintain a given energy efficiency level, parameters such as packet delay between first remote UE 403 and the U2N Relay 405 may need to be updated, e.g., to be able to maintain a given energy efficiency. For example, in case there is a burst size parameter related to the traffic between the first remote UE 403 and the U2N Relay 405, then the burst size parameter may be updated to maintain the energy efficiency level of interest.

The U2N Relay 405 may send a message to the first remote UE 403. This message may include energy related information, for example reporting information and notifications related to the energy-related event.

A possible action is for the U2N Relay 405 to send, in step S418, a link modification request to the first remote UE 403. The message may include the reason of the request, which for example can be that the energy usage per time period exceeded a certain threshold. The message may include the energy usage for the traffic of the first remote UE 403. The message may include updated parameters, such as QoS parameters, e.g., data rate, that can be used while maintaining an acceptable energy consumption/usage amount per time period, and/or maintaining the desired energy efficiency level for the traffic of the first remote UE 403 relayed by the U2N Relay 405. The message may include updated energy related parameters, such as updated energy consumption capacity per remote UE/per RSC (e.g., a lower energy consumption capacity), or updated minimum energy efficiency per remote UE/per RSC (e.g., a lower guaranteed EE level).

The first remote UE 403 may determine to accept or to reject the link modification proposal from the U2N Relay 405. Alternatively, the first remote UE 403 may be triggered to negotiate new parameters with the U2N Relay 405 based on the energy related information provided to the first remote UE 403 (e.g., notifications).

A related possible action is for the U2N Relay to send, in step S418, a link release request to the first remote UE 403, where the link release request may include the reason for the request.

Based on the outcome of the interaction between the first remote UE 403 and the U2N Relay 405, the link between the first remote UE 403 and the U2N Relay 405 may be released due to requirements not being able to be fulfilled. The link between the first remote UE 403 and the U2N Relay 405 may be updated with updated parameters either related to energy usage or QoS parameters.

Additionally, when the energy consumption related to the relaying of traffic by the U2N Relay 405 for the first remote UE 403 reaches a certain threshold, the U2N Relay 405 or the first remote UE 403 may determine to remove at least one PC5 QoS flow in the Prose connection between the U2N Relay 405 and the first remote UE 403, while keeping other PC5 QoS flows in the same Prose connection. For example, PC5 QoS flows that are either high energy consuming or are low priority PC5 QoS flows may be selected to be removed since the U2N relay 405 cannot support relaying their traffic due to the energy usage limit. The energy usage limit can be a per QoS flow energy usage limit or a per Prose connection between the U2N relay 405 and the first remote UE 403. Later, when the total energy consumption of the U2N relay 405 becomes lower, the PC5 QoS flows that were removed can be added to the Prose connection, with an adjustment to their QoS parameters and/or their energy related attributes, such as energy limit.

In response to the communication received in step S418, the first remote UE 403 may determine that other candidate U2N Relays may need to be considered due to the fact that the current U2N Relay 405 does not fulfill the (energy aware) requirements for the first remote UE 403 and RSC traffic relaying, or the fact that there can be improvements to the quality of relaying compared to the current U2N Relay 405.

In this case, the first remote UE 403 may, in step S420, perform a U2N Relay (re)discovery and (re)selection procedure considering energy related information, similar to step S406. The first remote UE 403 may have obtained information from different U2N Relays with different capabilities and relaying service and energy requirements and the first remote UE 403 may perform a selection of a new U2N Relay to continue relaying its traffic.

On the U2N Relay side, the first serving U2N Relay 405 selected in step S406 may have been configured by the core network 409 to perform actions when the energy related information of the U2N Relay 405 matches given attributes. For example, the U2N Relay 405 may have been configured to (temporarily) stop sending announcement message or to stop responding to other ProSe enabled UEs, for example due to the fact that the U2N Relay 405 is almost overloaded in terms of energy usage overall or that the energy savings ratings for the U2N Relay 405 may be impacted if the U2N Relay 405 connects to more remote UEs.

In this case, in step S422, the U2N Relay 405 may either stop sending announcement messages altogether or stop advertising support (e.g. in response to a discovery solicitation message from a second remote UE 401) for certain RSCs for example for which energy savings rating might be impacted. The U2N Relay 405 can send updated energy related information, for example, new values (i.e. thresholds) or energy capacity per remote UE and so on.

In case energy-saving relaying is preferred with a given priority but the support for it is no longer possible and a remote UE can fall back to non-energy saving modes, then the U2N Relay 405 and the remote UE may be configured with such information. For example, the U2N Relay 405 may be configured to support a best-effort energy aware relaying service that, in case energy saving is no longer possible, the U2N Relay can use to relay remote UE traffic with a given QoS while not taking energy saving into consideration.

A remote UE may also be configured to request a best-effort energy saving mode.

The U2N Relay 405 and the remote UE can discover support for such an energy saving mode during the discovery procedure and can further negotiate parameters related to this best-effort energy saving mode, during or after PC5 link establishment.

The U2N Relay 405 may be configured to inform the remote UE and the core network 409 of the energy saving mode that is used for relaying services of interest. The U2N Relay 405 may for example notify the remote UE when the U2N Relay 405 uses the best-effort energy saving mode and perhaps no longer takes energy saving into consideration for relaying traffic of interest for the remote UE.

The remote UE may use information to renegotiate parameters with the U2N Relay 405 or to release the link with the U2N Relay 405 and perform another direct discovery and selection of a U2N Relay that supports the remote UE desired energy saving mode.

The core network 409 may use the information of the energy savings mode the U2N Relay 405 uses to relay remote UE traffic to assess and update the energy savings rating of the U2N Relay 405 for the whole relaying operation, for relaying a specific RSC for the specific remote UE.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method at a relay device, the method comprising:
establishing a connection with a remote device;
monitoring energy consumption related to data traffic forwarded through the relay device for the remote device; and
in response to detecting an energy-related event affecting an ability of the relay device to respect an energy criterion negotiated with the remote device:
sending, to the remote device, information indicative of a request to alter the connection; and
altering the connection.

2. The method of claim 1, wherein the data traffic forwarded through the relay device for the remote device comprises at least one of:
data traffic originating at the remote device forwarded to a network and data traffic received from the network forwarded towards the remote device.

3. The method of claim 1, further comprising:
providing, to the remote device, energy-related information indicative of energy consumption related to data traffic transmission through the relay device.

4. The method of claim 1, wherein:
the connection with the remote device is established via at least one intermediate relay device.

5. The method of claim 1, wherein:
the connection is altered upon reception of information, received from the remote device, indicative of a response to the request.

6. The method of claim 1, wherein:
the information indicative of the request to alter the connection is a link modification request or a link release request.

7. The method of claim 1, wherein:
the energy criterion is negotiated during a discovery procedure involving the relay device and the remote device.

8. The method of claim 1, further comprising:
while the ability of the relay device to respect the energy criterion is affected, at least one of refraining from sending announcement messages and refraining from responding to discovery solicitation messages.

9. The method of claim 1, further comprising:
reporting energy usage of the relay device to a further entity; and
receiving from the further entity an estimate of energy usage of the data traffic forwarded through the relay device for the remote device, the estimate based on at least the reported energy usage of the relay device.

10. The method of claim 1, wherein:
the energy-related event affecting the ability of the relay device to respect an energy criterion is related to monitored energy usage attaining or exceeding a value agreed with the remote device.

11. A relay device comprising at least one processor configured to:
establish a connection with a remote device;
monitor energy consumption related to data traffic forwarded through the relay device for the remote device; and
in response to detecting an energy-related event affecting an ability of the relay device to respect an energy criterion negotiated with the remote device:
send, to the remote device, information indicative of a request to alter the connection; and
alter the connection.

12. The relay device of claim 11, wherein the data traffic forwarded through the relay device for the remote device comprises at least one of:
data traffic originating at the remote device forwarded to a network and data traffic received from the network forwarded towards the remote device.

13. The relay device of claim wherein the at least one processor is configured to:
provide, to the remote device, energy-related information indicative of energy consumption related to data traffic transmission through the relay device.

14. The relay device of claim 11, wherein the at least one processor is configured to:
establish the connection with the remote device via at least one intermediate relay device.

15. The relay device of claim 11, wherein the at least one processor is configured to:
alter the connection upon reception of information, received from the remote device, indicative of a response to the request.

16. The relay device of claim 11, wherein:
the information indicative of the request to alter the connection is a link modification request or a link release request.

17. The relay device of claim 11, wherein:
the energy criterion is negotiated during a discovery procedure involving the relay device and the remote device.

18. The relay device of claim 11, wherein the at least one processor is configured to:
while the ability of the relay device to respect the energy criterion is affected, at least one of refrain from sending announcement messages and refrain from responding to discovery solicitation messages.

19. The relay device of claim 11, wherein the at least one processor is configured to:
report energy usage of the relay device to a further entity; and
receive from the further entity an estimate of energy usage of the data traffic forwarded through the relay device for the remote device, the estimate based on at least the reported energy usage of the relay device.

20. The relay device of claim 11, wherein:
the energy-related event affecting the ability of the relay device to respect an energy criterion is related to monitored energy usage attaining or exceeding a value agreed with the remote device.
